(19) United States
(12) Patent Application Publication
(10) Pub. No.: US 2007/0102485 A1
(43) Pub. Date: May 10, 2007

(54) SOLDERING METHOD AND APPARATUS

(75) Inventors: Hiroshi Fukaya, Hong Kong (HK); Satoshi Yamaguchi, Hong Kong (HK)

Correspondence Address: GREENBLUM & BERNSTEIN, P.L.C., 1950 ROLAND CLARKE PLACE, RESTON, VA, 20191, US

(73) Assignee: SAE MAGNETICS (H.K.) LTD., Hong Kong (HK)

(21) Appl. No.: 11/538,172

(22) Filed: Oct. 3, 2006

(30) Foreign Application Priority Data
Oct. 31, 2005 (JP) 2005-317547

(51) Int. Cl. A47J 36/02

(52) U.S. Cl. 228/101

(57) ABSTRACT

It is a soldering method for bonding, by solder, each bonding pad formed on respective bonding targets to be bonded to each other. The method comprises the steps of: a pad heating step for irradiating heating beams while the solder is placed on irradiation paths of the heating beams in such a manner that each bonding pad is heated before the solder is melted; and a solder melting step for melting the solder by the heating beams to be attached on each bonding pad, wherein the heating beams are irradiated almost simultaneously in the pad heating step and the solder melting step, and a molten solder heating step is provided thereafter for further heating the molten solder on the bonding pads by the heating beams.

### BACKGROUND OF THE INVENTION

1. Field of the Invention

The present invention relates to a soldering method and an apparatus thereof and, more particularly, to a soldering method and apparatus for bonding, by soldering, each bonding pad formed on respective bonding targets which are to be bonded to each other.

2. Description of the Related Art

Soldering is to perform bonding through heating and melting solder on a bonding pad surface where a gold-plated layer is formed, so that the solder and the gold on the bonding pad surface are fused to form a gold-tin alloy. It is used as a means for bonding electronic components to a substrate and the like, for example. By way of example, as shown in FIG. 1A, it is used when fabricating a magnetic head assembly 101 by soldering a magnetic head slider 114 having a magnetic head element 115 as an electronic component to a suspension 11 to which a flexible printed circuit 112 is integrated.

A typical method for soldering will be described here by referring to FIG. 12. As shown in this illustration, a solder ball 104 (or paste-type solder) is placed in advance on a junction area where a bonding pad 113 of the suspension 111 side and a bonding pad 116 of the magnetic head slider 114 side are located. Alternatively, it is set at the tip of a laser irradiation device 102 (nozzle). Then, the solder is melted by irradiating laser beams from the nozzle 102 and the molten solder is attached to each of the bonding pads 113 and 116 in the junction area to perform soldering.

Subsequently, a more detailed example of the soldering method will be described First, the method shown in FIG. 2A is a method in which the solder ball 104 is inserted into the nozzle 102 of a laser torch to be discharged from the tip of the nozzle to the junction area, thereby bonding the bonding pads 113 and 116 by the molten solder. Further, a soldering apparatus utilizing a method shown in FIG. 3A comprises, first of all, the nozzle 102 formed in a shape that is tapered towards the tip and, at the same time, a laser irradiating part placed above the nozzle. In that state, the tip opening of the nozzle 102 is formed in a smaller diameter than that of the solder ball 104, and a suction device (not shown) is connected inside the nozzle 102. By the operation of the suction device, the solder ball 104 is sucked from the tip side of the nozzle 102 and the solder ball 104 is held at the tip of the nozzle 102. Soldering is performed by irradiating laser beams through moving the sucked solder ball to the junction area.

However, the opening diameter of the laser torch in the conventional case is formed in a circular shape by corresponding to the shape of the solder ball 104, and the size thereof is set larger or smaller with respect to the external shape of the solder ball 104. For example, in the case of the above-described method shown in FIG. 2A, it is formed larger than the external shape of the solder ball 104. Meanwhile, in the case of the above-described method shown in FIG. 3A, it is formed smaller than the external shape of the solder ball 104. Thus, in the case of FIG. 2A where it is formed larger, there is caused such an inconvenience that laser beams L leak from the gaps in the periphery of the solder ball 104 so that the laser beams are irradiated out of the area of the bonding pads 113 and 116. Therefore, the laser intensity distribution of this case becomes the one as indicated by reference code LA of FIG. 2B, and there may be a risk of damaging the members (for example, polyimide and she like for constituting a flexure) in the periphery of the bonding pads 113 and 116. Furthermore, in the case of FIG. 3A where the opening diameter of the nozzle is formed smaller than the solder ball 104, the laser beams L are irradiated only to the solder ball, which causes such an inconvenience that the laser beams are not irradiated at all to the bonding pads. Therefore, the laser intensity distribution of this case becomes the one as indicated by reference code LB of FIG. 3B. Thus, the temperatures of the bonding pads 113 and 116 are not sufficiently increased and the wettability of the molten solder is deteriorated, which may deteriorate the reliability of the solder bonding, e.g. generating connection failure.

Patent Literature 1 noted below discloses a technique for solving such shortcomings. In the invention thereof, as shown in FIG. 4B, a mask 121 is arranged at the tip part of a nozzle 102. Thereby, the shape of the opening from which laser beams are irradiated is constituted with a circular hole 122 and slits 123, 124 crossing the hole 122. As shown in FIG. 4A, a laser beam L101 passing through the hole 122 is set to irradiate the solder ball 104, while the laser beams L102 and L013 passing through the slits 123, 124 are set to irradiate the bonding pads 113 and 116. With this, the bonding pads 113 and 116 are heated before the solder 104 is bonded, so that the wettability can be improved. FIG. 4C shows the state where the bonding pads are bonded by the molten solder 140.

However, when the bonding targets of the above-described soldering are electronic components as described above, the electronic components may be heated to a temperature higher than the heat-resistant temperature thereof by the heat applied at the time of soldering. This may cause damaging of the electronic components by the heat of soldering. Therefore, heating of the solder by the laser or the like has conventionally been restricted to a short time.

[Patent Literature 1] Japanese Unexamined Patent Publication 2005-123581

However, when heating of solder is restricted to a short time, fusion of the solder becomes insufficient due to the short-heating time. Thus, as noted below, stable soldering cannot be achieved.

That is, when the heating time of soldering is insufficient, diffusion of gold from the bonding pads 113, 116 to the solder 117 becomes insufficient. FIG. 5A shows a crystallographic picture of the solder 117 after soldering is performed with a short heating time, and FIG. 5B shows an enlarged picture R11′ that is a part of an area R11. In these pictures, white needle-shaped substance is the gold-tin alloy. As shown in areas indicated by reference numerals R11 and R12 in FIG. 5A, the gold-tin alloy is concentratedly formed in the vicinity of the bonding pad surfaces 113 and 116, Thus, a gold-tin alloy layer is formed in the vicinity of the bonding pad surfaces 213 and 116, and tin alloy is formed in other areas. Therefore, the solder 140 in the junction area is divided into the gold-tin alloy and the tin alloy, so that solder cracks are likely to be generated at the boundary surface between each alloy. In addition, solder separation is likely to be generated since the strength of the tin alloy is weak. As a result, reliability of soldering is decreased. The part where the above-described gold-tin alloy layer is formed and bonding becomes insufficient may particularly be generated at the areas (areas indicated by reference numerals 141) which are most distant from the center area of heating and insufficiently heated.

### SUMMARY OF THE INVENTION

The object of the present invention therefore is to improve the inconveniences of the above-described conventional cases and, in particular, to provide a soldering method and an apparatus thereof which can achieve highly reliable soldering.

Therefore, one form of the present invention is a soldering method for bonding, by solder, each bonding pad formed on respective bonding targets to be bonded to each other. The method comprises steps of: a pad heating step for irradiating heating beams while the solder is placed on irradiation paths of the heating beams in such a manner that each bonding pad is heated before the solder is melted; and a solder melting step for melting the solder by the heating beams to be attached on each bonding pad, wherein the heating beams are irradiated almost simultaneously In the pad heating step and the solder melting step, and a molten solder heating step is provided thereafter for further heating the molten solder on the bonding pads by the heating beams.

With the present invention, first, the solder placed on the irradiation paths is heated by the irradiation of the heating beams, and the bonding pads are heated at the same time. By the irradiation of the heating beams, the solder is melted thereafter, and the molten solder in attached onto the bonding pads. By heating the bonding pads in this manner before fusion of the solder, the bonding pads can be cleaned and activated by the heat. Thus, wettability of the solder for the bonding pads can be improved so that reliability of soldering can be improved. Through continuing irradiation of the heating beams for the molten solder further, the molten solder is heated and the gold on the bonding pads can be diffused over the entire solder. Thereby, the strength of the solder is improved and the reliability of soldering can be improved. In this manner described above, it becomes possible for improve the efficiency of heating by the heating beams and, at the same time, reliability of soldering can be improved by a simple method.

Further, the pad heating step irradiates the heating beams to the bonding pads through a periphery of the solder. Thereby, the solder and the bonding pads can be heated effectively, so that energies can be utilized effectively.

Further, the pad heating step irradiates the heating beams in an amount of heat with which the solder is not melted within a prescribed time. Furthermore, the pad heating step irradiates heating beams with an intensity weaker than that off the heating beams irradiated in the solder melting step. Moreover, the molten solder heating step irradiates heating beams with an intensity weaker than that of the heating beams in the solder melting step. With this, it is possible to achieve heating of the bonding pads and dispersion of the gold as described above or allowing an improvement in the reliability of soldering, while suppressing excessive heating of the bonding targets. Therefore, generation of malfunctions due to the heat of the bonding targets can be suppressed.

Further, irradiation of the heating beams in each of the steps is performed continuously. With this, soldering can be achieved by performing the irradiation once. Thus, It is possible to improve the reliability of t soldering as described above, while simplifying the soldering step.

The pad heating step is performed while the solder is placed in advance on the bonding pads. Alternatively, the pad heating step is performed while the solder is held at a tip of an irradiation device for irradiating the heating beams. Furthermore, the pad heating step irradiates the heating beams to each bonding pad before placing the solder on the irradiation paths of the heating beams, and the solder is placed on the irradiation paths during irradiation of the heating beams to each bonding pad. The molten solder heating step discharges the molten solder or the solder before being melted from the tip of the irradiation device of the heating beams to attach the solder on the bonding pads. As described, the present invention can be utilized for various kinds of soldering methods, so that highly reliable soldering can be achieved by various kinds of methods.

Further, the molten solder heating step heats at least the vicinity of outer periphery of the solder melted on the bonding pads. At that time, the molten solder heating step performs heating in such a manner that gold is diffused in the molten solder from the bonding pads. With this, the outer periphery of the molten solder, which tends to be heated insufficiently, can be heated efficiently and the gold from the bonding pads can be diffused into the molten solder. Thus, it is possible to suppress generation of a gold-tin alloy layer in the vicinity of the bonding pads, so that the bonding strength by the solder can be improved.

Furthermore, irradiation of the heating beams at least in the pad heating step is performed through an irradiation mask that restricts irradiation areas of the heating beams. At that time, it is preferable to perform irradiation of the heating beams in the molten solder heating step through the irradiation mask as well. With this, the irradiations areas of the heating beams can be easily set, so that highly reliable soldering as can be achieved by a simple method as described above.

Further, the heating beams are irradiated, respectively, to each bonding pad as irradiation targets. At that time, the heating beams are irradiated simultaneously to the bonding pads which are positioned at a plurality of junction areas, respectively. Furthermore, the heating beams are irradiated, respectively, with intensities set in advance in accordance with positions of the bonding pads or with intensities set in advance in accordance with each of the bonding pads. With this, it is possible to heat only the bonding pads effectively before melting the solder. At the same time, diffusion of the gold from the vicinity of the bonding pads to the molten solder can be more promoted after the solder is melted as well. Therefore, excessive heating of the bonding targets and the like can be suppressed to prevent the damages thereof. At the same time, secure bonding can be achieved, and the reliability of soldering can he improved. Furthermore, by simultaneously performing irradiations to each of the plurality of bonding pads, the soldering step can be simplified. Moreover, through performing laser irradiations by setting the intensities of the laser beams in accordance with the positions of the bonding pads or in accordance with each of she bonding pads, a proper amount of heat can be applied to each pad. Therefore, thermal damages to the bonding targets can be suppressed further.

Further, the present invention manufactures a head gimbal assembly in which a magnetic head slider is bonded to a suspension by the above-described soldering. Furthermore, the present invention manufactures a magnetic disk device in which the head gimbal assembly is loaded, Like this, by forming the head gimbal assembly and the magnetic disk device by employing the above-described soldering method for bonding the magnetic head slider, it becomes possible to manufacture the magnetic disk device with still higher reliability.

Another form of the present invention is a soldering apparatus used for bonding, by solder, each bonding pad formed on respective bonding targets to be bonded to each other. The apparatus comprises an irradiation device having a nozzle for irradiating heating beams to a junction area, and a control device for controlling irradiation state of the heating beams through controlling action of the irradiation device, wherein: at a tip of the nozzle, there are formed a solder irradiation hole for irradiating the heating beams to solder placed on irradiation paths of the heating beams and bonding-pad irradiation holes for irradiating the heating beams to the bonding pads; and the control device controls action of the irradiation device to irradiate the heating beams, respectively, to the junction area, before and after the solder is melted.

Before melting the solder, the control device controls action of the irradiation device to irradiate the heating beams in an amount of heat with which the solder is not melted within a prescribed time. Further, before melting the solder, the control device controls action of the irradiation device to irradiate the heating beams with an intensity weaker than that of irradiation for melting the solder. Furthermore, after the solder is melted, the control device controls action of the irradiation device to irradiate the heating beams with an intensity weaker than that of irradiation for melting the solder. Moreover, the control device controls action of the irradiation device to irradiate the heating beams continuously.

The irradiation device irradiates the heating beams to solder placed in advance on the bonding pads. Alternatively, the irradiation device performs soldering under a state where the solder is held at the tip of the nozzle. Further, the irradiation device performs soldering by supplying solder to the tip of the nozzle after starting irradiation of the heating beams to each bonding pad. The irradiation device performs soldering by discharging the solder placed at the tip of the nozzle onto the bonding pads to attach the solder thereon.

The bonding-pad irradiation holes are formed in a shape, size, or at positions with which the heating beams can be irradiated to the bonding pads through a periphery of the solder. Furthermore, the bonding-pad irradiation holes are formed in a size so that, when the heating beams passed through the bonding-pad irradiation holes are irradiated to the bonding pads, irradiation areas thereof do not exceed areas of the bonding pads.

Furthermore, another constitution of the soldering apparatus is a soldering apparatus used for bonding, by solder, each bonding pad formed on respective bonding targets to be bonded to each other. The apparatus comprises an irradiation device having a nozzle for irradiating heating beams to a junction area, and a control device for controlling irradiation state of the heating beams through controlling action of the irradiation device, wherein; the nozzle of the irradiation device is formed to be capable of irradiating the heating beams, respectively, to each bending pad as irradiation targets; and the control device controls action of the irradiation device to irradiate the heating beams, respectively, before and after melting the solder.

The irradiation device irradiates the heating beams simultaneously to a plurality of the bonding pads which are positioned at a plurality of junction areas, respectively. Further, the control device performs irradiations, respectively, with intensities set in advance in accordance with positions of the bonding pads.

The soldering apparatuses with the above-described constitutions also function like the above-described soldering method, so that it is possible to achieve highly reliable soldering that is the object of the present invention as described above.

The present invention is constituted and functions as described above. With this, the bonding pads can be heated before fusion of the solder used for bonding, so that the bonding pads can be cleaned and activated by the heat. Thus, wettability of the solder for the bonding pads can be improved, and the reliability of soldering can be improved. Further, through continuing irradiation of the heating beams for the molten solder, the molten solder is heated and the gold on the bonding pads can be diffused over the entire solder. Thereby, the strength of the solder is improved further, so that the reliability of soldering can be improved further. Those are excellent effects that have not been achieved conventionally.

### BRIEF DESCRIPTION OF THE DRAWINGS

FIG. 1A is an illustration of soldering targets for describing a soldering apparatus according to a conventional case;

FIG. 1B is an illustration for showing the state of soldering performed to the soldering targets shown in FIG. 1A;

FIG. 2A is an illustration for showing an example of a soldering method according to the conventional case;

FIG. 2D is an illustration for showing the intensity distribution of laser beams that are irradiated to solder in the soldering method shown in FIG. 2A;

FIG. 3A is an illustration for showing an example of a soldering method of the conventional case;

FIG. 3B is an illustration for showing she intensity distribution of laser beams that are irradiated to the solder in the soldering method shown in FIG. 3A;

FIG. 4A is an illustration for showing the structure of the soldering apparatus according to the conventional case;

FIG. 4B is a front elevational view of the tip part of a nozzle shown in FIG. 4A;

FIG. 40 is an illustration for showing the state after performing soldering by the soldering apparatus shown in FIG. 4A;

FIG. 5A is a crystallographic picture of the solder after performing soldering in the conventional case;

FIG. 5F is fragmentary enlarged picture of FIG. 5A;

FIG. 6A is a schematic view for showing the structure of a soldering apparatus according to a first embodiment;

FIG. 6B is a front elevational view of the tip part of a nozzle shown in FIG. 6A;

FIG. 7A is an illustration for showing the state when irradiation of laser beams is started in the first embodiment;

FIG. 7B is an illustration for showing the irradiation state of the laser beams in the first embodiment;

FIG. 8A is an illustration for showing the state where the solder is melted at a junction area in the first embodiment;

FIG. 8B is an illustration for showing the state of the solder when the laser beams are irradiated continuously further after the state of FIG. 8A;

FIG. 8C is an illustration for showing the state of the solder after the state of FIG. 8B;

FIG. 9A is a crystallographic picture for showing the state of the solder after performing soldering;

FIG. 9B is a fragmentary enlarged picture of FIG. 9A;

FIG. 10 is a flowchart for showing the operation of the soldering apparatus according to the first embodiment;

FIG. 11 is a flowchart for showing the operation of the soldering apparatus according to a second embodiment;

FIG. 12A is a schematic view for showing the structure of a soldering apparatus according to a third embodiment;

FIG. 12B is a front elevational view of the tip part of a nozzle shown in FIG. 12A;

FIG. 13 is a flowchart for showing the operation of the soldering apparatus according to the third embodiment;

FIG. 14A is a schematic view for showing the structure of a soldering apparatus according to a fourth embodiment;

FIG. 14B is a schematic view for showing the structure of the soldering apparatus according to the fourth embodiment;

FIG. 15 is a flowchart for showing the operation of the soldering apparatus according to the fourth embodiment;

FIG. 16A is a front elevational view of the tip part of a nozzle according to a fifth embodiment;

FIG. 16B is an illustration for showing the irradiation state of the laser beams that are irradiated from the nozzle in the fifth embodiment;

FIG. 17A is an illustration for showing the state when laser beams are irradiated in a sixth embodiment;

FIG. 17B is an illustration for showing the state when laser beams are irradiated in the sixth embodiment;

FIG. 18A is an illustration for showing an example of the laser irradiation intensities of each bonding pad in the sixth embodiment;

FIG. 18B is an illustration for showing the state when laser beams are irradiated to the bonding pads in the sixth embodiment;

FIG. 18C is an illustration for showing the temperature distribution on the bonding pad when the laser beams are irradiated in the sixth embodiment;

FIG. 18D is an illustration for showing the temperature distribution en the bonding pad when the laser beams are irradiated in the sixth embodiment; and

FIG. 19 is an illustration for showing the structure of a magnetic disk device according to a seventh embodiment.

### DETAILED DESCRIPTION OF THE PREFERRED EMBODIMENTS

The present invention is distinctive in respect that the solder pads are heated in the junction area before melting the solder when soldering the bonding pads to each other, and heating is continued further after the solder is melted. With this, the wettability oaf the solder for the bonding pads can be improved. At the same time, gold on the bonding pads can be diffused over the entire molten solder, so that the bonding strength can be improved and highly reliable soldering can be achieved.

Embodiments in the followings will be described by referring to the case where a magnetic head slider is bonded to a suspension. That is, there will be described the case of bonding, by solder, a bonding pad to be a connecting terminal of a magnetic head slider as a bonding target and a bonding pad to be a connecting terminal of a flexible printed circuit on which a wiring race integrated with a suspension is formed. It is noted, however, that the present invention can be applied to soldering performed on any kinds of bonding targets.

### First Embodiment

A first embodiment of the present invention will be described by referring to FIG. 6-FIG. 10. FIG. 6 is a schematic view for showing the structure of a soldering apparatus. FIG. 7-FIG. 8 are illustrations for describing the state at the time of soldering. FIG. 9 is a crystallographic picture for showing the state of the solder after soldering is performed. FIG. 10 is a flowchart for describing actions at the t-me of soldering performed by the soldering apparatus.

[Structure]

A soldering apparatus 20 according to this embodiment fabricates a head gimbal assembly 1 by solder-bonding a magnetic head slider 14(bonding target) to a suspension 11 (bonding target). As shown in FIG. 6A, the soldering apparatus 20 comprises a laser irradiator (irradiation device) having a nozzle 2 for outputting laser beams (heating beams) to heat the solder, and a controller 3 (controlling device) for controlling the action of the entire apparatus. In the followings, each structure will be described in detail.

First of all, the soldering targets (bonding targets) in this embodiment are the magnetic head slider 14 and the suspension 11. Specifically, a bonding pad 16 (slider-side bonding pad) that is a connecting terminal formed in a magnetic head device part 15 of the magnetic head slider 14 is connected by using solder to a bonding pad 13 (board-side bonding pad) that is a connecting terminal formed on a flexible printed circuit 12 that is integrated with the suspension 11. In other words, this area becomes the solder junction area. The present invention is particularly effective when bonding both solder pads 13 and 16 arranged roughly at a right angle. The solder used herein is lead-free solder, however, the solder is not limited to such type.

The laser irradiator outputs diode lasers from the nozzle 2. The irradiation action of the laser beams from the nozzle 2 is controlled by the controller 3. That is, the controller 3 controls the output value, irradiation time, irradiation position, etc, of the laser beams, respectively. The description thereof will be provided later

The laser irradiator employs the structure in which a solder ball 4 is held at a position between a tip part 21 of the nozzle 2 and the bonding pads 13, 16, and lasers are irradiated in this state to fuse the solder hall 4 to perform soldering. However, as will be described in other embodiments, there may be employed a structure in which the solder ball 4 is held only by the nozzle 2, and the solder is discharged to the junction area from the position away from the bonding pads 13, 16 to dispose the molten solder to the junction area. Further, there may be employed a structure in which soldering is performed by irradiating laser beams to the solder that is placed in advance on the bonding pads 13, 16 (junction area, without holding the solder ball 4 at the nozzle 2. The type of the laser, the structure and the like of the laser irradiator are not limited to those described above. Furthermore, other irradiators that output heating beams may be used as the device for heating the solder.

FIG. 6B shows the tip part 21 of the nozzle 2 when viewed from the front. As shown in this illustration, a laser output port (irradiation mask) through which the laser beams are outputted is formed at the nozzle tip part 21. As the laser output port, there are formed a solder irradiation hole 22 formed with a circular hole smaller than the external shape of the solder ball 4 and slit-type bonding-pad irradiation holes 23, 24 which cross almost the center of the solder irradiation hole 22. With this, the laser beams are outputted through each of the holes 22, 23, and 24, so that the irradiation area of the beams can be restricted thereby. Specifically, the laser beams outputted from the solder irradiation hole 22 are irradiated to the solder ball 4 held mainly at the tip part 21 as will be described later. Further, as will be described later, the laser beams outputted from the bonding-pad irradiation holes 23, 24 are irradiated to the bonding pads 13, 16. In the above, there has been described that each of the above-described holes 22, 23, 24 serving as the laser output port is directly formed in the tip part 21. However, a member (irradiation mask) in which such holes are formed may be mounted at the tip part 21 to achieve restriction of the irradiation areas of the laser beams as described above.

The controller 3 controls the irradiation condition of the laser beams at the tame of soldering. In this embodiment, in particular, it is controlled to perform one-time continuous irradiation of laser beams from the start of the irradiation to melt the solder ball 4, and to irradiate the laser beams thereafter for a prescribed time as well. The irradiation time thereof is controlled. In the followings, the state of the laser beams at the time of irritation and the state of the solder thereof will be described by referring to FIG. 7-FIG. 8.

First, laser beams are irradiated while the solder ball 4 is held at the tip part 21 of the nozzle 2. With this, laser beams are outputted as indicated by reverence numerals L1, L2, and L3 in FIG. 7A. Among those, the laser beam L1 is outputted from the solder irradiation hole 22, and the laser beams L2, L3 are outputted from the bonding-pad irradiation holes 23, 24. Thus, the laser beam L1 is irradiated to the solder ball 4, and the laser beams L2, L3 are irradiated onto the respective bonding pads 13, 16 through the periphery of the solder ball placed on the irradiation paths of the laser beams. The irradiation area of the laser beams in that state is indicated by reference numeral L10 in FIG. 7B. The laser beams are irradiated while being set at the intensity with which the solder ball 4 is not melted in a short time, so that the amount of heat sufficient to fuse the solder ball 4 is applied only after performing irradiation of the laser beams for a certain time. Therefore, for the certain time before the solder ball 4 is melted, the laser beans L2, L3 are also irradiated to each of the bonding pads 13, 16 as shown by reference numeral L10 in FIG. 7B to heat the bonding pads 13 and 16 are heated, while heating the solder ball 4.

Then after the certain time for irradiating the laser beams has passed, the solder 40 s melted as shown in FIG. 8A and attached between each of the bonding pads 13, 16. The controller 3 continues to perform heating thereafter also for a certain time. That is, as shown in FIG. 5A and FIG. 5B, the laser beams L1, L2, L3 outputted from the solder irradiation hole 22 and the bonding-pad irradiation holes 23, 24 formed in the tip part 21 of the nozzle 2 are irradiated to molten solder 40. Therefore, not only the center of the molten solder 40 but also the vicinity of the outer periphery of the molten solder 40 is heated especially by the laser beams L2 and L3.

By referring to the schematic illustrations of FIG. 8A and 8B, there will now be described the state of the solder 40 when irradiation of the laser beams L1, L2, L3 are continued to the molten solder 40 for the certain time after the solder has been melted as has been described above. First, as shown in FIG. 8A, gold 41 from the bonding pads 13, 16 placed in the vicinity of the surfaces of both bonding pads 13, 16 comes to diffuse over the entire solder 40 by continuous heating of the solder 40. That is, as shown by arrows in the solder 40 of FIG. 8B, the gold in the vicinity of the surface of the board-side bonding pad 13 is diffused over the entire solder, while the gold is the vicinity of the surface of the slider-side bonding pad 16 is drawn to diffuse towards the opposite side, i.e. in the direction of the board-side bonding pad 13. With this, the gold is diffused over the entire solder 40 and the gold-tin alloy can be distributed uniformly as shown in FIG. 8C.

FIG. 9A shows the crystallographic picture of the solder 40 after performing the above-described soldering, in which the white needle-shape and dot-shape substances are the gold-tin alloys. It can be seen from the picture that the gold-tin alloys are diffused uniformly over the entire solder. FIG. 9B is an enlarged picture of the solder 40 in the vicinity of the slider-side bonding pad 16. Compared to the conventional case shown in FIG. 5B, it can be seen that the gold-tin alloys are not concentrated in the vicinity of the surface of the bonding pad 16 but distributed uniformly.

With this, the gold on the bonding pads 13, 16 comes to diffuse over the entire solder 40 so that the gold-tin alloys can be distributed uniformly, thereby improving the strength of the solder. Furthermore, overheating of the magnetic head slider 14 (magnetic head element part 15) can be suppressed at this time, so that it is possible to protect the magnetic head slider 14.

After the laser beams are irradiated for the certain time in this manner, the controller 3 operates to stop the irradiation of the laser beams

The irradiation time of the laser beams is set in such a manner that the magnetic head element of the magnetic head slider is not broken down by the heat even the laser beams with the set laser intensity are irradiated for that time and, as described above, the gold can be properly diffused. It is set to the time that is determined in advance based on an experiment, analysis, logical operation, and experience.

[Operation]

Next, the soldering operation by the above-described soldering apparatus will be described by referring to a flowchart of FIG. 10 and illustrations of FIG. 6-FIG. 9.

First, the solder ball 4 is set to be held at the tip part 21 of the nozzle 2 (step S1). Then, as shown in FIG. 6A, the position of the nozzle 2 is set by moving the nozzle 2 so that the solder ball 4 comes in contact with the bonding pad 13 formed in the suspension 11 and the bonding pad 16 formed in the magnetic headslider 14 (step S2). At this stage, for example, the solder ball 4 may be held by being sucked by the nozzle 2 from the tip side, or it may be pinched between the tip part 21 of the nozzle 2 and the bonding pads 13, 16 by moving the tip part 21 of the nozzle 2 to the position of the solder ball 4 that is placed in advance to be in contact with the bonding pads 13, 16.

In the above-described state, as shown in FIG. 7A, irradiation of the laser beams from the nozzle 2 is started (step S3), and the irradiation is performed for the set time with the intensity set in advance. With this, first, the laser beam L1 outputted from the solder irradiation hole 22 of the nozzle 2 is irradiated to the solder ball 4. Further, the laser beams L2 and L3 outputted from the bonding-pad irradiation holes 23 and 24 (slit-type holes) of the nozzle 2 are irradiated to the bonding pads 13, 16 through the periphery of the solder ball 4 (see reference numeral L10 of FIG. 7B). This irradiation state is continued for a prescribed time until the solder ball 4 is melted, and each of the bonding pads 13 and 16 is heated during this time (step S4, pad heating step). As described above, the intensity of the laser beams is weak to such an extent that the amount of heat capable of melting the solder ball 4 is not applied in a short time within which the bonding pads 13, 16 are not heated to the state suitable for soldering with the laser beams L2, L3 that have passed through the bonding-pad irradiation holes 23, 24.

Thereafter, when the irradiation is continued for the prescribed time and the amount of the heat that is enough to fuse the solder ball 4 is applied by the above-described laser beam L1, the solder is melted as shown in FIG. 8A (step S5, solder melting step). Thereby, the molten solder 40 is attached to both bonding pads 13 and 16. In that state, both bonding pads 13, 16 have already bean heated so that cleaning and activation of the bonding pads 13, 16 have been achieved by the heat. Thus, the wettability of the solder is improved, which enables highly reliable soldering.

Thereafter, irradiation of the laser beams L1, L2, L3 is continued further for a prescribed time (molten solder heating step). With this, as shown in FIG. 8A, the entire molten solder 40 is heated and, in particular, not only the center of the molten solder 40 but also the vicinity of the cuter periphery is heated. Upon this, the gold from the bonding pads 13, 16 concentrated in the vicinity of the junction area between the molten solder 40 and the bonding pads 13, 16 is diffused over the entire solder 40 as the gold 41 shown in FIG. 8B and FIG. 8C by the heat applied further (step S6). After a prescribed time has passed from the fusion of the solder and a preset time has passed from the start of laser irradiation step S3), the irradiation of laser is stopped (step S7). That is, one-time continuous irradiation of laser beams from the steps S3-S7 is ended.

With this, it is possible with one-time irradiation of the laser beams to heat the bonding pads 13, 16 before melting the solder to improve the wettability and, at the same time, to heat the molten solder 40 further after melting the solder to disperse the gold. Therefore, it is possible to improve the efficiency of applying heat by the laser beams and the reliability of soldering by a simple method, which enables improvements in the quality of the products produced by the soldering as well as reduction of the manufacturing cost.

### Second Embodiment

Next, a second embodiment of the present invention will be described by referring to FIG. 11. The soldering apparatus 20 of this embodiment has almost the same structure as that of the first embodiment, except that the control of the laser beam irradiation by the controller 3 is different. In the followings, this point will be described in detail. Other structures are same as those of the first embodiment, so that the descriptions thereof are omitted.

[Structure]

Before the solder is melted, the controller 3 (controlling device) according to this embodiment controls to perform irradiation by setting the intensity of the laser beams weaker than that of the laser beams irradiated when melting the solder as will be described later. That is, there are irradiated the laser beams with low intensity with which the sclder hall 4 is not melted within a time set in advance from the start of the laser irradiation. Further, the controller 3 controls to irradiate the laser beams with stronger intensity than that, after the above-described preset time has passed. The time for irradiating the laser with this strong intensity is the time that is considered in advance to be enough to fuse the solder hall 4. Thereafter, the controller 3 controls to irradiate the laser beams with weaker intensity than the intensity for melting the solder as described above, after the solder is melted. The laser irradiation is controlled in this manner to irradiate the laser beams with weak, strong, weak intensities from the start of laser irradiation for each set time.

[Operation]

Next, the operation of the soldering apparatus 20 with the above-described structure will be described by referring to FIG. 11. Preparations such as setting the solder ball 4 at the tip part 21 of the nozzle 2 and setting the position of the nozzle 2 by moving it are the same as the above-described case (steps S11, S12)

When irradiation of the laser beams is started (step S13), first, the laser beams are irradiated for a prescribed time by setting the intensity weak so that the solder ball 4 is not melted (step S14, pad heating step). During this, the bonding pads 13 and 16 are heated, and the wettability is improved. Thereafter, the laser beams with the intensity set stronger than earlier are irradiated for a prescribed time (step S15, solder melting step). With this, the solder ball 4 is melted, and the molten solder 40 is attached to both bonding pads 13, 16. Thereafter, the laser beams with the intensity set weaker than earlier are irradiated for a prescribed time (step S16, molten solder heating step). Thereby, gold is diffused entirely in the molten solder 40, thus increasing the bonding strength. Then, laser irradiation is stopped after a prescribed time (step S17).

As described above, by setting the intensity of the laser beams to be weak before and after melting the solder ball 4, excessive heating of the magnetic head slider and the suspension as the bonding targets can be suppressed. Thus, damages to the magnetic head element part, deformation of the suspension, etc. caused by heat can be suppressed. As a result, the quality of the products can be improved.

Irradiation of the laser beams in the steps from S13 to S17 is achieved by one-time continuous irradiation. However, irradiation of the laser beams may be stopped when changing the intensity, in order to perform irradiation by setting new intensity for each time. In other words, the above-described soldering may be achieved by irradiating the laser beams for a plurality of times in a single solder bonding process.

### Third Embodiment

Next, a third embodiment of the present invention will be described by referring to FIG. 12-FIG. 13. FIG. 12 illustrates the structure of the soldering apparatus according to this embodiment, and FIG. 13 is a flowchart for showing the operation thereof.

[Structure]

As shown in FIG. 12A and FIG. 12B, the soldering apparatus according to this embodiment performs irradiation of the laser beams L1, L2, L3 while holding the solder ball 4 at the tip part 21 of the nozzle 2, and the solder 40 melted by the laser irradiation is discharged onto the bonding pads 13, 16 positioned in the junction area (see an arrow with dotted line in FIG. 12A) to attach the solder 40 on the bonding pad 13, 16 for achieving soldering.

The structure of the soldering apparatus will be described in more detail. As shown in FIG. 12A, the shape of the nozzle 2 is the same as that described above, and the solder ball 4 is held at the solder irradiation hole 22 among the laser output ports formed in the tip part 21 through which the laser beams are outputted. Regarding the method for holding the solder ball 4, it may be held at the solder irradiation hole 22 by sucking or the solder ball may be pushed into the solder irradiation hole 22 to be held therein.

FIG. 126 shows the tip part 21 of the nozzle 2 viewed from the front. As shown in this illustration, long-and-narrow substantially oval shape bonding pads 23, 24 are formed across the solder irradiation hole 22 at which the solder ball 4 is held. In the nozzle 2, the solder ball 4 is melted by irradiation of the laser beams as will be described later, and the molten solder is discharged from the tip part 21 by a pressing force such as a gas. The solder discharged from the nozzle 2 onto the bonding pads 13, 16 may be in the form of solder ball before being melted, and it may be melted on the bonding pads 13, 16 by the heat of the bonding pads 13, 16 that are heated in advance or by the laser beams irradiated further.

[Operation]

Next, the operation of the soldering apparatus with the above-described structure will be described by referring to a flowchart of FIG. 13 and the illustrations of FIG. 12. First, the solder bail 4 is set at the tip part 21 of the nozzle 2 (step S21), and the position of the nozzle 2 is moved to be set at the position capable of discharging the solder from the nozzle tip part 21 onto the bonding pads 13, 16 (step S22) as shown in FIG. 12A.

When irradiation of the laser beams is started (step S23), first, the laser beam L1 outputted from the solder irradiation hole 22 of the nozzle 2 is irradiated to the solder ball 4. Further, the laser beams L2 and L3 outputted from the bonding-pad irradiation holes 23 and 24 of the nozzle 2 are irradiated to the bonding pads 13, 16 through the periphery of the solder ball 4 (see FIG. 12A)). This irradiation state is continued for a prescribed time until the solder ball 4 is melted (pad heating step). Thereby, the bonding pads 13, 16 are heated until the solder ball 4 is melted (step 324), and cleaning and activation thereof is achieved by the heat. Thus, the wettability of the solder can be improved.

Thereafter, when the irradiation is continued for the prescribed time and the amount of the heat that is enough to fuse the solder ball 4 is applied by the above-described laser beam L1, the solder is melted at the nozzle tip part 21 (step S25, solder melting step). Thereby, the molten solder 40 is discharged from the solder irradiation hole 22 by the pressing force of the gas within the nozzle 2 and disposed to the bonding pads 13 and 16 (step S26). The solder discharged onto the bonding pads 13, 16 may be in the form of solder ball as it is without being melted, and it may be melted on the bonding pads 13, 16 by the heat of the bonding pads 13, 16 or by the laser bean L1 after being discharged.

Thereafter, irradiation of the laser beams L1, L2, L3 is continued further for a prescribed time (molten solder heating step). With this, in the same manner described above, the entire molten solder 40 is heated on the bonding pads 13, 16 and, in particular, not only the center of the molten solder 4C but also the vicinity of the outer periphery is heated. Upon this, the gold 41 from the bonding pads 13, 16 concentrated in the vicinity of the junction area between the molten solder 40 and the bonding pads 13, 16 is diffused over the entire solder by the heat applied further (step S27). After a prescribed time has passed from the fusion of solder and a preset time has passed from the start of laser irradiation (step S23), the irradiation of laser beams is stopped (step S28).

As described above, it Is also possible with this soldering method to achieve highly reliable soldering as described above.

As has been described in the second embodiment, the intensity of the laser beams may be controlled by the controller 3 or by manual operation at the time of laser irradiation in the snaps From S23-S28 described above. That is, it may be set to irradiate the laser beams with relatively weak intensity at the time of heating the pads immediately after the start of laser irradiation and at the time of dispersing the gold after the solder is melted.

### Fourth Embodiment

Next, a fourth embodiment of the present invention will be described by referring to FIG. 14-FIG. 15. FIG. 14 shows the illustrations of the structure of the soldering apparatus according to this embodiment, and FIG. 15 is a flowchart for showing the operation thereof.

[Structure]

As shown in FIG. 14A, the soldering apparatus according to this embodiment does not hold the solder ball 4 at the tip part 21 of the nozzle 2 in advance. It employs the structure in which the solder ball 4 or the molten solder is supplied to the tip part 21 after starting the irradiation of the laser beams. For example, as shown in FIG. 14A, the solder ball 4 is inserted into the nozzle 2 at the time of irradiating the laser beams (see an arrow Y2), which is then moved to the tip part 21 (see an arrow Y3 with dotted line). Thereby, as shown in FIG. 14B, the solder ball 4 or the solder melted within the nozzle 2 is held temporarily in the solder irradiation hole 22 of the tip part 21, so that the solder is discharged onto the bonding pads 13, 16 (see an arrow Y4 with dotted line) like the above-described case. The soldering apparatus of this embodiment performs soldering by providing the solder on the bonding pads 13 and 16 in this manner.

[Operation]

Next, the operation of the soldering apparatus with the above-described structure will be described by referring to a flowchart of FIG. 15 and the illustrations of FIG. 14. First, as shown in FIG. 14A, the position of the nozzle 2 is moved to be set at the position capable of discharging the solder from the nozzle tip part 21 onto the bonding pads 13, 16 (step S31) Then, laser irradiation is started (step S32).

In this embodiment, the solder ball 4 is not placed at the tip part 21 of the nozzle 2, so that all the outputted laser beams L1, L2, L3 are irradiated to the bonding pads 13, 16 that function as the junction area, thereby heating the bonding pads 13, 16 (step S33). While the laser beams are irradiated, the solderball 4 is inserted into the nozzle 2 (step S34). Thereby, the solder ball 4 is placed at the nozzle tip part 21 (pad heating step) as shown in FIG. 14B.

Thereafter, when the amount of the heat that is enough to fuse the solder ball 4 is applied by the above-described laser beams, the solder melted at the nozzle tip part 21 is discharged from the solder irradiation hole 22 by the pressing force of the gas within the nozzle 2. Thereby, the molten solder is attached to the bonding pads 13 and 16 (step S35, solder melting step).

Thereafter, irradiation of the laser beams L1, L2, L3 is continued further for a prescribed time (molten solder heating step). With this, in the same manner described above, the entire molten solder 40 is heated on the bonding pads 13, 16 and, in particular, not only the center of the molten solder 40 but also the vicinity of the outer periphery is heated. Upon this, the gold 41 from the bonding pads 13, 16 concentrated in the vicinity of the junction area between the molten solder 40 and the bonding pads 13, 16 is diffused ever the entire solder by the heat applied further (step S36). After a prescribed time has passed from the fusion of solder and a preset time has passed from the start of laser irradiation (step S32), the irradiation of laser beams is stopped (step S37).

As described above, it is also possible with this soldering method to achieve highly reliable soldering as described above.

As has been described in the second embodiment, the intensity of the laser beams may be controlled by the controller 3 or by manual operation at the time of laser irradiation in the steps from S32-S37 described above. That is, it may he set to irradiate the laser beams with relatively weak intensity at the time of heating the pads immediately after the start of laser irradiation and at the time of dispersing the gold after the solder is melted.

### Fifth Embodiment

Next, a fifth embodiment of the present invention will be described by referring to FIG. 16. FIG. 16A is a front elevational view of the tip part 21 of the nozzle 2, and FIG. 16B is an illustration for showing the irradiation state of the laser beams irradiated from the nozzle 2.

The aforementioned embodiments have been described by referring to the case where the bonding-pad irradiation holes 23, 24 provided in the tip part 21 of the nozzle 2 are formed in a long-and-narrow slit shape across the solder irradiation hole 22. However, it should not be limited to that. For example, as shown in FIG. 16A, the bonding-pad irradiation holes 23 and 24 may be formed in a shape having a wider width. The irradiation state of the laser beams irradiated from such bonding-pad irradiation holes 23, 24 to the bonding pads 13, 16 is shown by reference numerals L11, L12 in FIG. 16B. As shown in the illustration, the irradiated area of the bonding pads 13 and 16 by the laser beams becomes wider since the bonding-pad irradiation holes 23, 24 are formed larger than those formed in the other embodiments described above. Thus, the bonding pads 13 and 16 can be heated effectively.

The bonding-pad holes 23 and 24 may not necessarily have to be formed by being connected to the solder irradiation hole 22, but each of the holes may be formed as independent holes Further, the number, shape and size of the holes are not limited to the above-described ones. However, as shown in FIG. 16B, it is necessary to set the shape, size and positions thereof so that the irradiation area of the bonding pads 13, 16 by the laser beams passing through the bonding-pad irradiation holes 23, 24 does not exceed the area of the bonding pads 13, 16, and the laser beams are not irradiated out of the bonding pads 13, 16.

### Sixth Embodiment

Next, a sixth embodiment of the present invention will be described by referring to FIG. 17-FIG. 18. FIG. 17 shows the structure of the soldering apparatus according to this embodiment, and FIG. 18 shows illustrations for showing the state of laser irradiation.

As shown in FIG. 17A, the soldering apparatus according to this embodiment has a plurality of laser irradiation ports formed in the nozzle 2. The laser irradiation ports are formed particularly in accordance with the positions of the bonding pads placed at the bonding area, i.e. the positions of the board-side bonding pad 13 formed on the suspension 11 and the slider-side bonding pad 16 formed in the magnetic head slider 14 at the time of solder bonding, so as to irradiate the laser beams only to the respective pads. For example, in the embodiment, six each of the bonding pads 13, 16 are arranged in pairs as shown in FIG. 17B. In accordance with this, a total of twelve laser irradiation ports are formed in two lines vertically and six lines horizontally to enable irradiation of the laser beams. With this, the laser beams L11 and L12 can be irradiated separately to the individual bonding pads 13 and 16.

Specifically, in this embodiment, a plurality of laser irradiation tubes are mounted inside the laser torch 2. Thus, the laser beams pass through each tube in the laser torch 2, and the laser beams L11, L12 are irradiated from each tube to each of the bonding pads 13, 16. In other words, the laser irradiation ports are constituted with each of the tubes. When one side of each of the substantially square bonding pads 13, 16 is 80 μm, for example, the diameters of the laser irradiation tubes are formed to be capable of irradiating the circular laser beams having the diameter almost in the same length as the one side of the pads. The diameter can be set arbitrarily, however, it is desirable to be as capable of irradiating the laser beams to the range within the area of the bonding pads.

It is so constituted that the intensities of each of the laser beams L11, L12 irradiated to the respective bonding pads 13, 16 can be set, respectively, by the controller 3. FIG. 18 shows an example of the control of the laser beam intensity. As shown in FIG. 18A, among the bonding pads 13, 16 arranged in the lateral direction, the intensities thereof are set to become stronger towards the outer side, respectively, from the bonding pads (3, 4) positioned in the center. In other words, the intensities of the laser beams for the bonding pads (1, 6) positioned at the outermost are the strongest, and it becomes gradually weaker towards the center. For the other bonding pads lined in the vertical direction, the intensities of the laser beams are set in the same manner to perform irradiation. Specifically, the intensities are set to be capable of heating the bonding pads to 220-350° C.

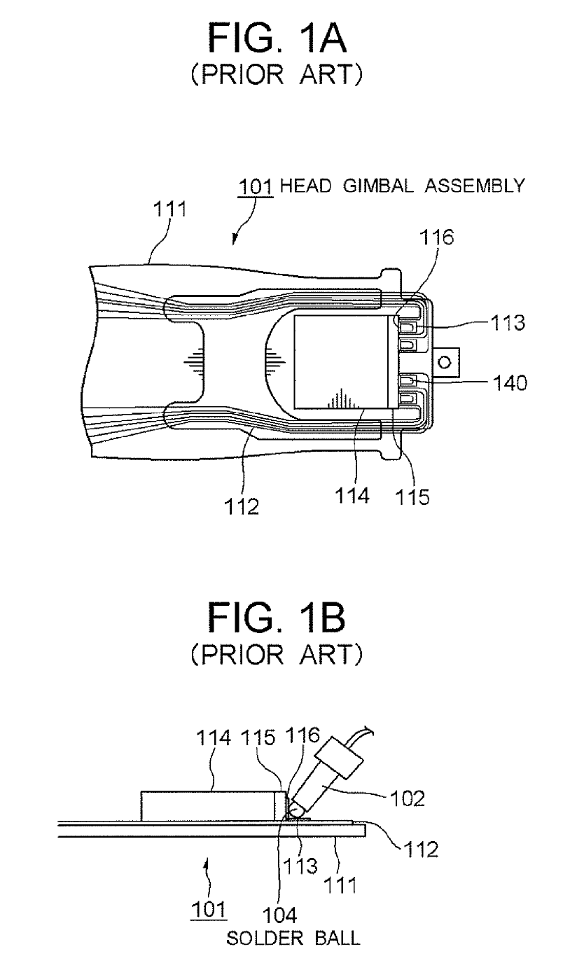

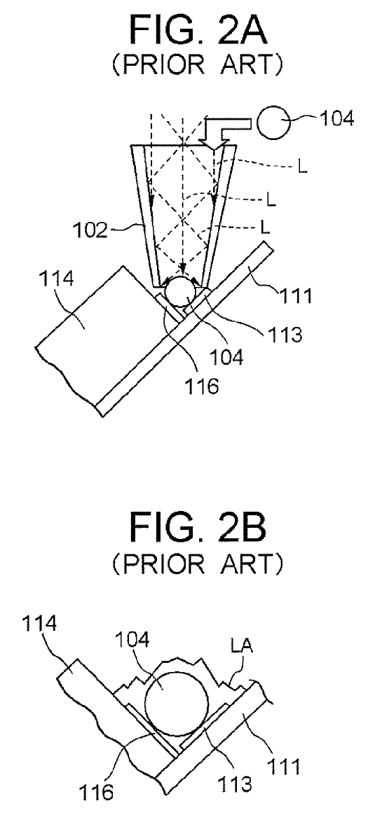

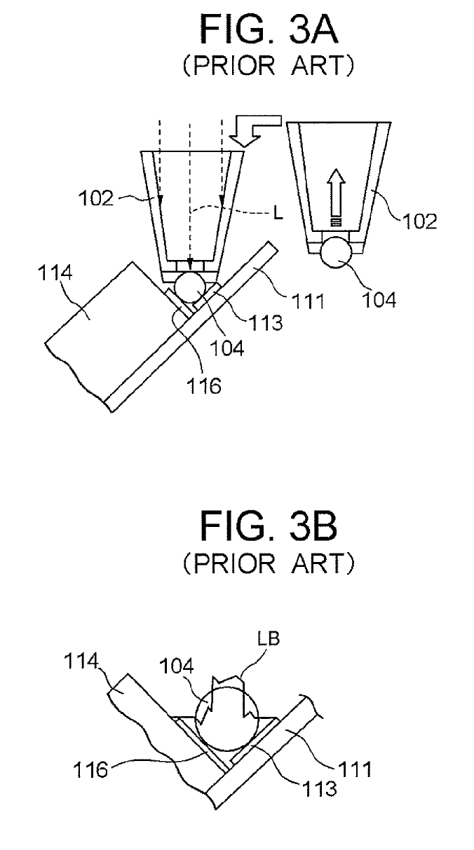

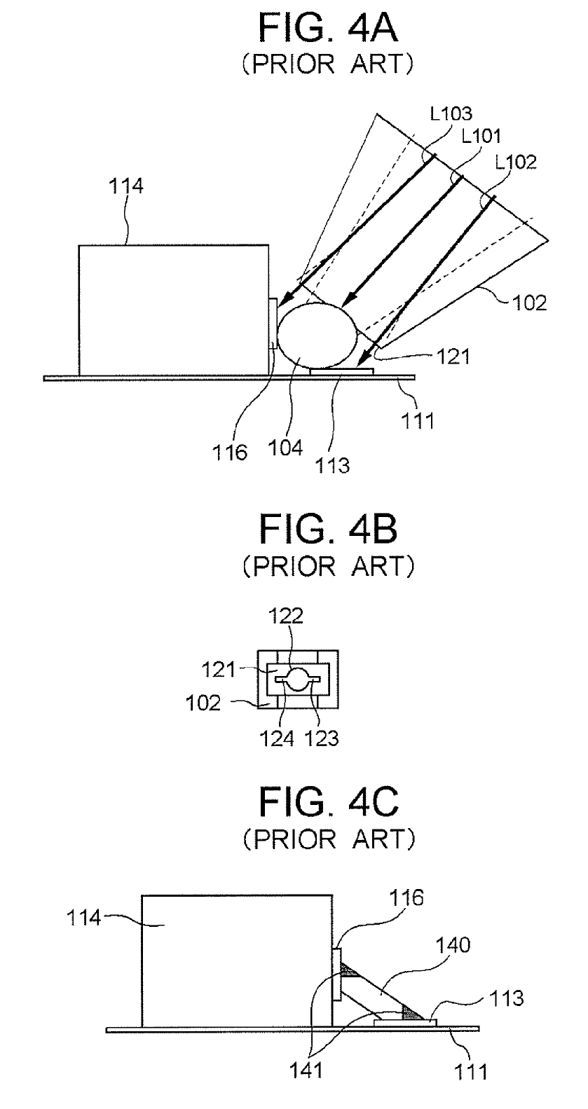

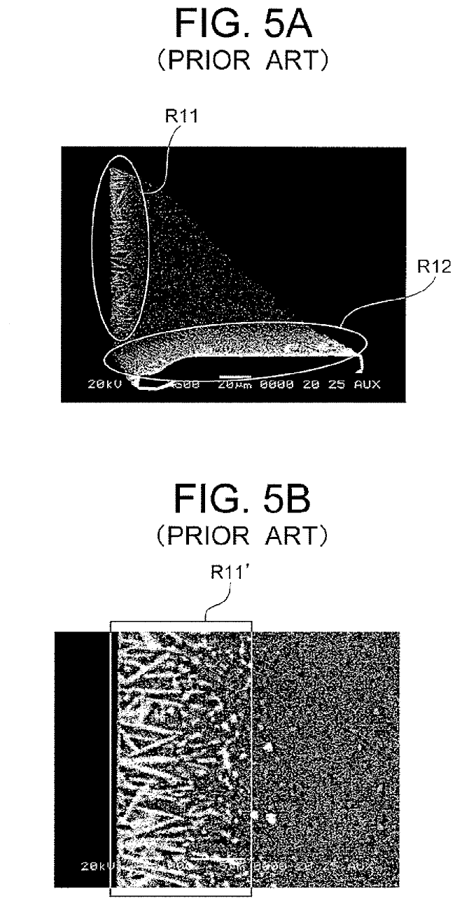

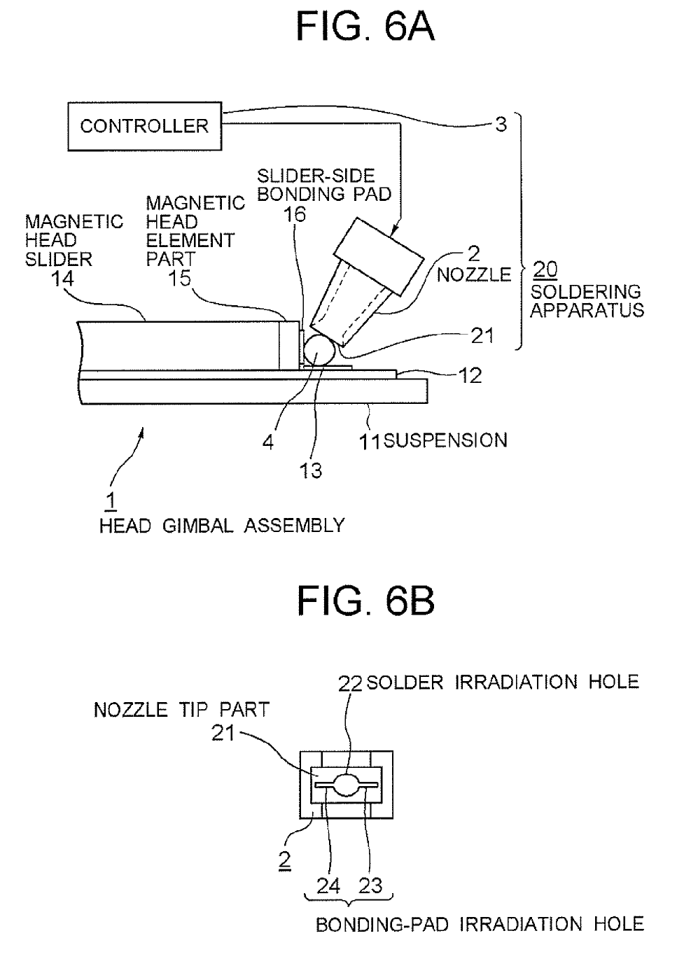

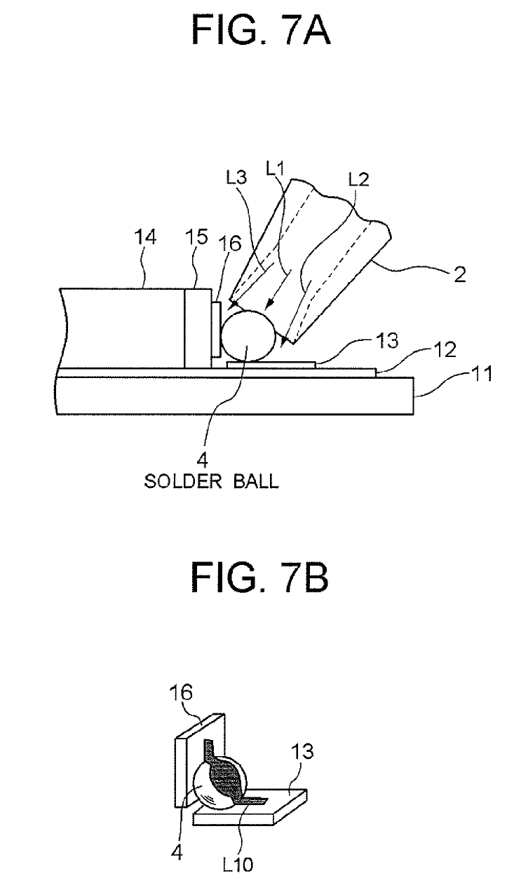

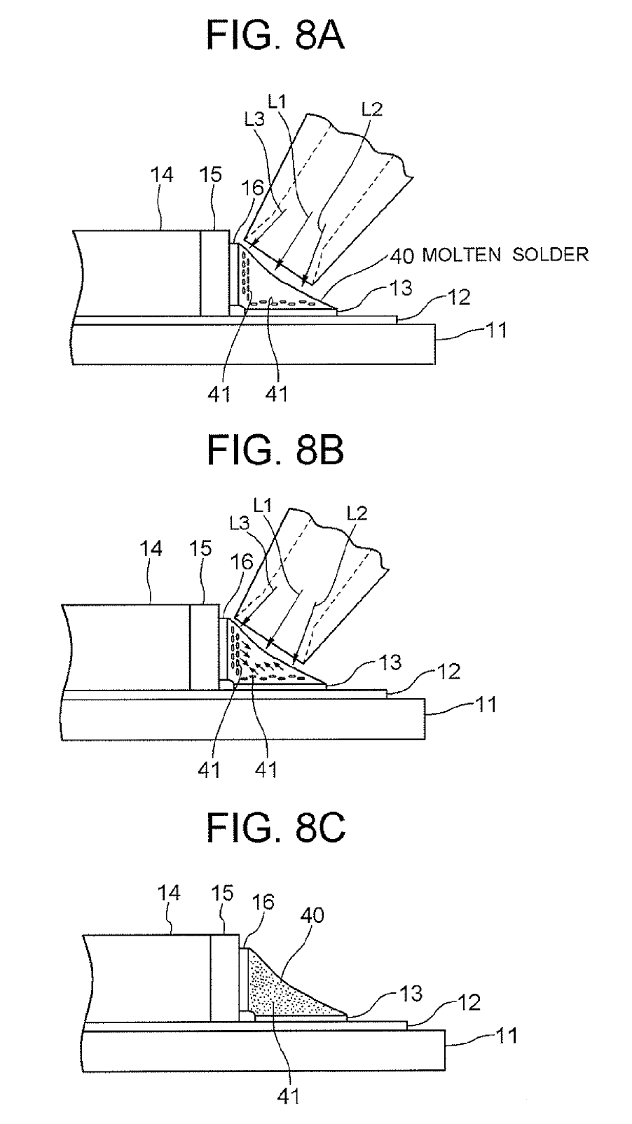

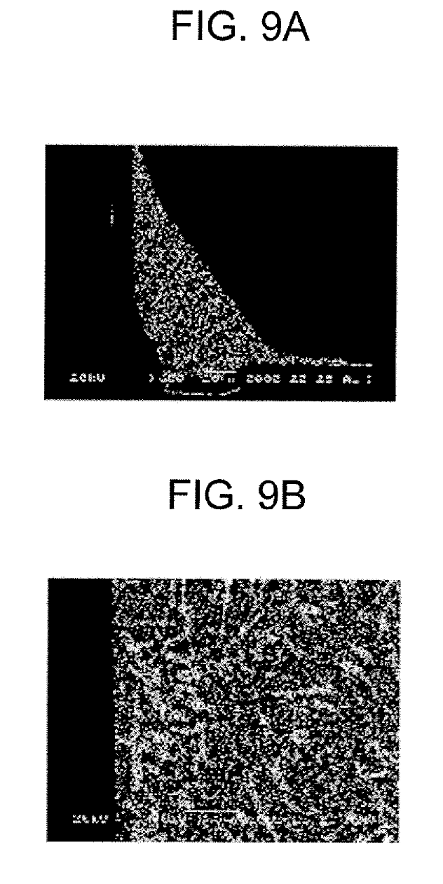

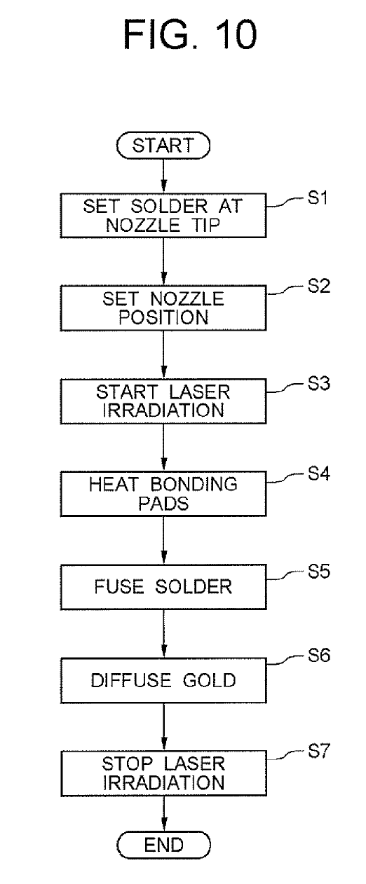

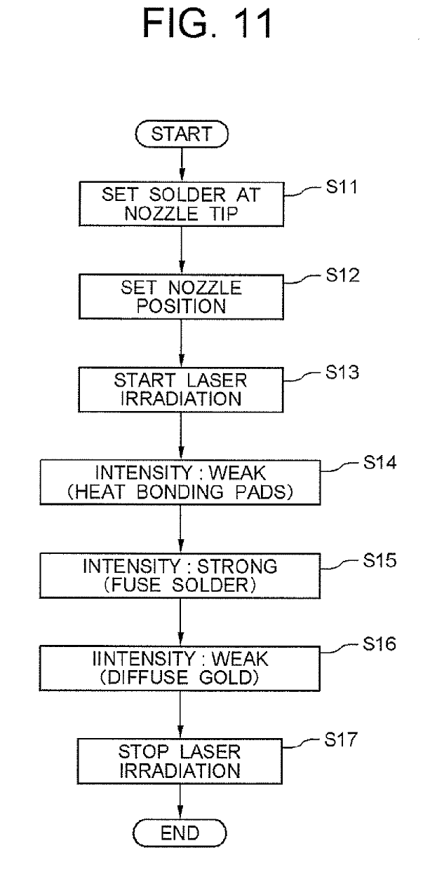

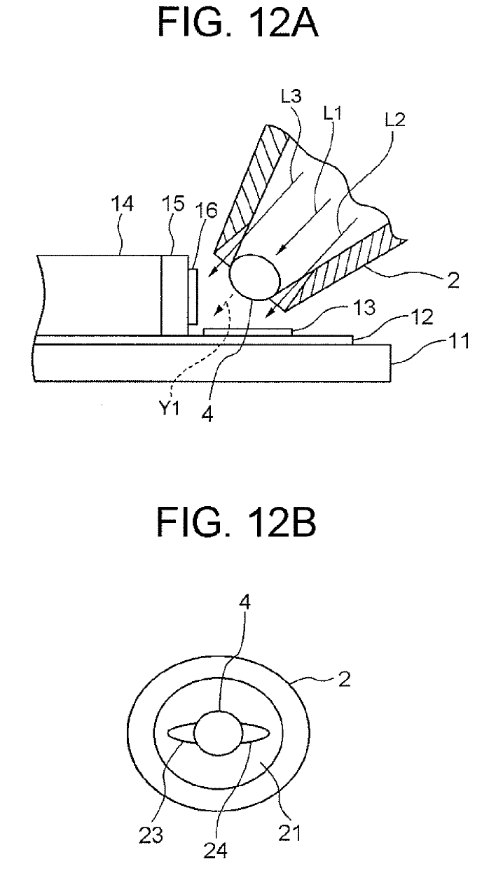

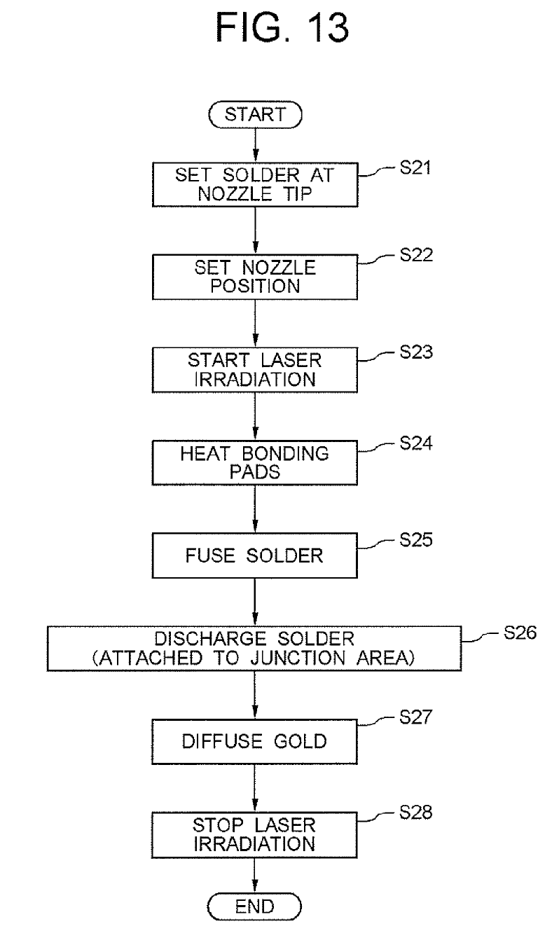

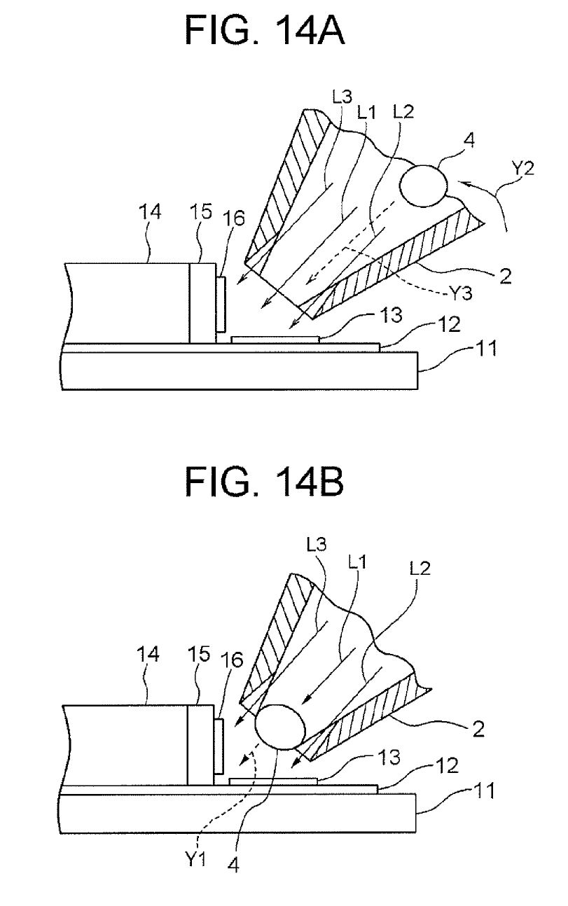

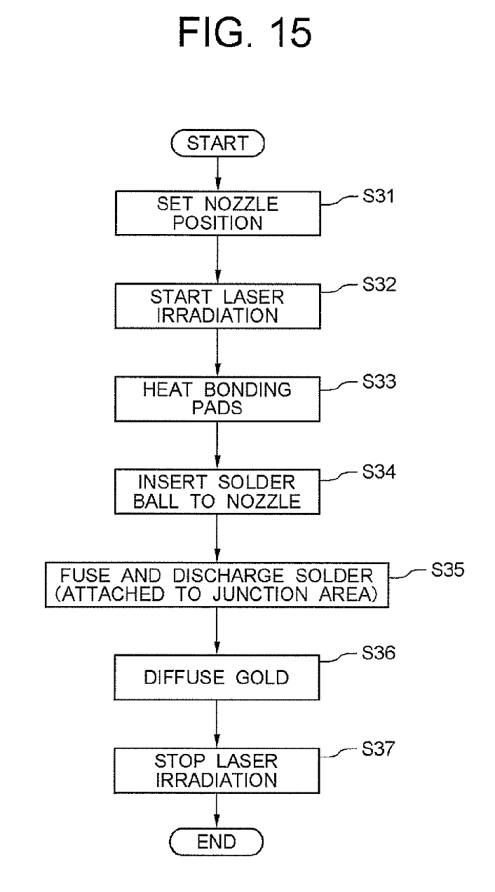

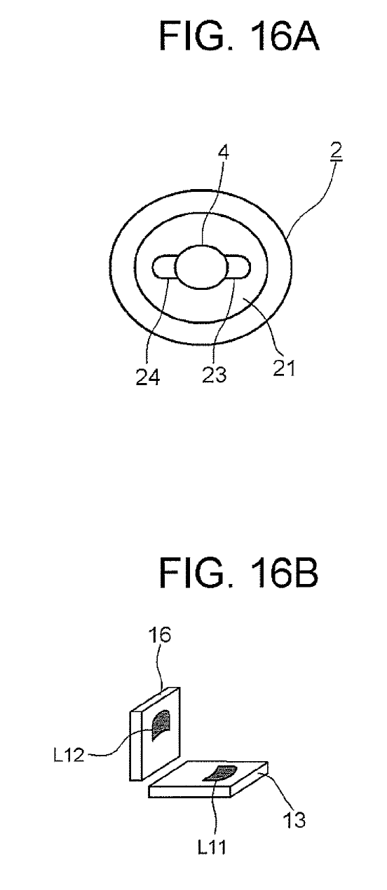

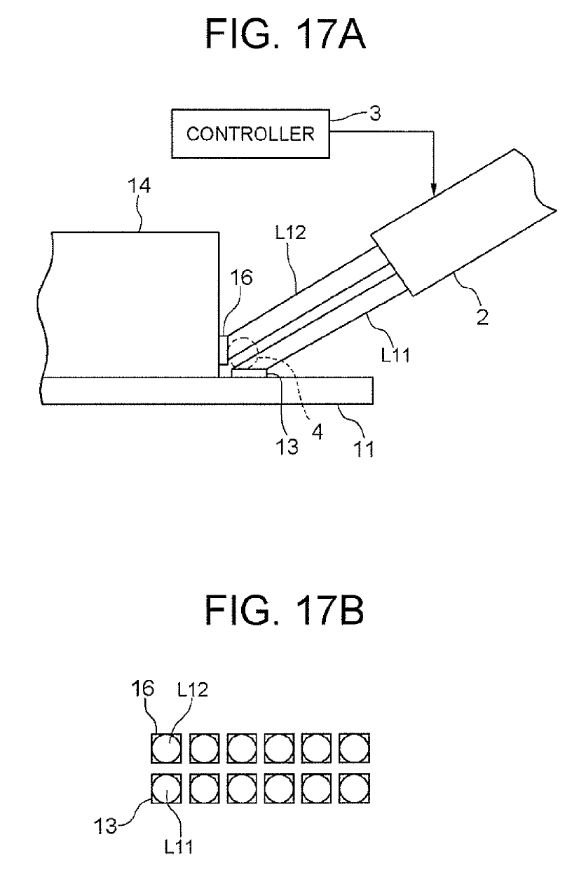

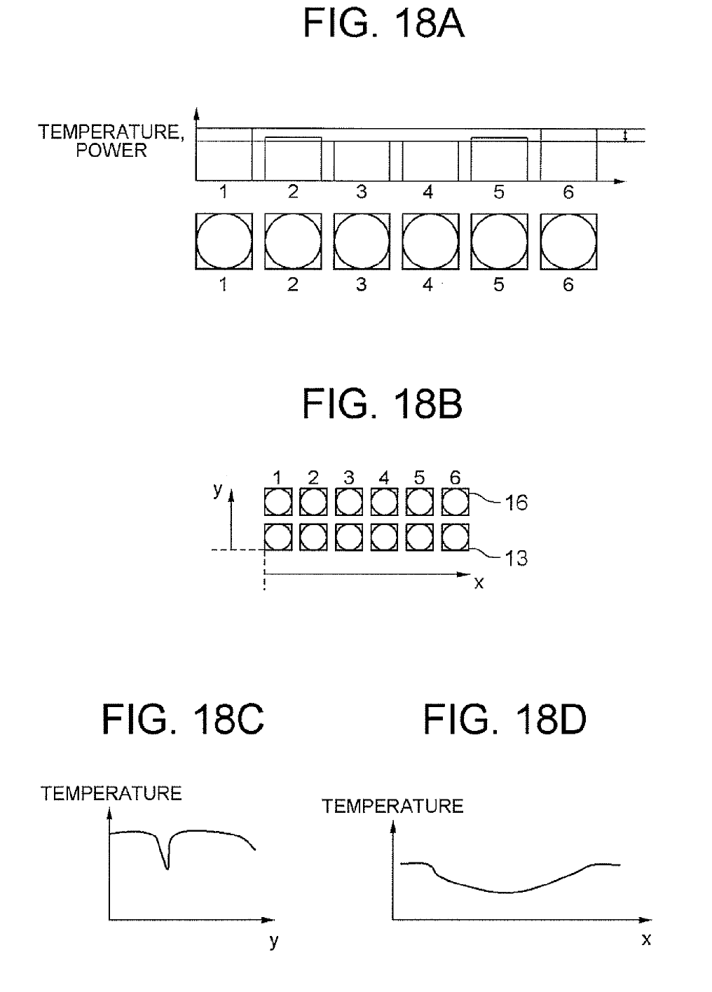

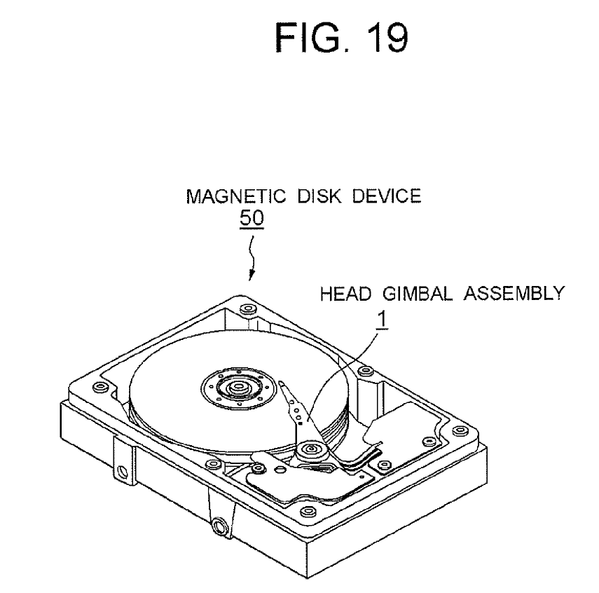

With this, the temperature distributions in the vertical direction (y direction in FIG. 18B) and the lateral direction (x direction in FIG. 1D) at the time of irradiating the laser beams to each of the bonding pads 13, 16 become those shown in FIG. 18C and FIG. 18D, respectively. That is, for the temperature distribution in the vertical direction (y direction) as shown in FIG. 18C, the temperature is decreased in the vicinity of the center since the laser beams L11, L12 are not irradiated between the slider-side bonding pad 16 and the board-side bonding pad 13. Further, for the temperature distribution in the lateral direction (X direction), the temperature of the pads positioned on the outer side is high since the intensities of the laser beams L11, L12 are controlled by each irradiating position as described above, and the temperature becomes lower as the position of the pad comes closer to the center.

The reason for controlling the intensities of the laser beams in the manner as described above is that the temperature required for each of the pads 13, 16 differs in accordance with the positions of the bonding pads 13, 16 and the incident angle of the laser beams. For example, thee temperature is kept within the pad in the vicinity of the center, so chat soldering can be achieved with a smaller amount of heat compared to the pads on the outer side.

While controlling the intensities of the laser beams by using the above-described nozzle 2, irradiation of the laser beams is carried cut for heating the pads before melting the solder, then melting the solder, and diffusing the gold thereafter. With this, each of the bonding pads 13, 16 can be heated before the solder is melted and, at this time, excessive heating of the area other than the bonding pads 13, 16, e.g. the magnetic head slider part 15 of the magnetic head slider 14 and the FPC 12 of the flexure 11, can be suppressed. Thus, damages thereof can be prevented. Furthermore, the heat applied to the bonding pads 13, 16 after melting the solder can promote dispersion of the gold from the vicinity of the bonding pads 13, 16 to the molten solder. At the time of performing a series of heating described above, a proper amount of heat can be applied by the laser beams in accordance with the positions of each of the bonding pads 13, 16, so that the excessive heating can be suppressed further.

Control of the intensities of the laser beams L11, L12 for each of the bonding pads 13, 16 performed by the controller 3 is not limited to the above-described one. It is noted here that the bonding pad 13 (on the magnetic head slider 14 side) to which the laser beam L12 is irradiated tends to exhibit a high endothermic effect because the magnetic head slider 14 serves as a heat sink. In other words, due to the heat-sink effect of the magnetic head slider 14, the bonding pad 16 is more likely to release the heat. Thus, it is not easily heated up compared to the bonding pad 13. Based on this, it may be controlled to irradiate the laser beam L12 with higher intensity than that of the laser beam L11, for example. With this, the amount of heat necessary For the respective junction areas can be applied within the same irradiation time, so that the solder bonding can be achieved simultaneously and uniformly.

### Seventh Embodiment

Next, a seventh embodiment of the present invention will be described by referring to FIG. 19. FIG. 19 shows a magnetic disk device 50 according to this embodiment.

As described above, by soldering the magnetic head slider 14 to the suspension 11 through the soldering method according to the present invention, failure of the magnetic head slider 14 can be suppressed and highly reliable solder bonding can be achieved. Therefore, by manufacturing the magnetic disk device 50 having the above-described head gimbal assembly 1 mounted thereon, it is possible to achieve the conditions such as high reliability and high quality that are required for the magnetic disk device.

The soldering method and the soldering apparatus according to the present invention can be utilized for soldering the electronic components that require highly reliable solder bonding. Thus, it has the industrial applicability.

What is claimed is:

1. A soldering method for bonding, by solder, each bonding pad formed on respective bonding targets to be bonded to each other, said method comprising steps of:
a pad heating step for irradiating heating beams while said solder is place on irradiation paths of said heating beams in such a manner that said each bonding pad is heated before said solder is melted; and a solder melting step for melting said solder by said heating beams to be attached on said each bonding pad, wherein
said heating beams are irradiated almost simultaneously in said pad heating step and said solder melting step, and
a molten solder heating step is provided thereafter for further heating said molten solder on said bonding pads by said heating beams.

2. The soldering method according to claim 1, wherein said pad heating step irradiates said heating beams to said bonding pads through a periphery of said solder.

3. The soldering method according to claim 1, wherein said pad heating step irradiates said heating beams in an amount of heat with which said solder is not melted within a prescribed time.

4. The soldering method according to claim 1, wherein said pad heating step irradiates heating beams with an intensity weaker than that of said heating beams irradiated in said solder melting step.

5. The soldering method according to claim 1, wherein said molten solder heating step irradiates heating beams with an intensity weaker than that of said heating beams in said solder melting step.

6. The soldering method according to claim 1, wherein irradiation of said heating beams in each of said steps is performed continuously.

7. The soldering method according to claim 1, wherein said pad heating step is performed while said solder is placed in advance on said bonding pads.

8. The soldering method according to claim 1, wherein said pad heating step is performed while said solder is held at a tip of an irradiation device for irradiating said heating beams.

9. The soldering method according to claim 1, wherein said pad heating step irradiates said heating beams to said each bonding pad before placing said solder on said irradiation paths of said heating beams, and said solder is placed on said irradiation paths during irradiation of said heating beams to said each bonding pad.

10. The soldering method according to claim 8, wherein said molten solder heating step discharges said molten solder or said solder before being melted from said tip of said irradiation device of said heating beams to attach said solder on said bonding pads.

11. The soldering method according to claim 1, wherein said molten solder heating step heats at least a vicinity of outer periphery of said solder melted on said bonding pads.

12. The soldering method according to claim 11, wherein said molten solder heating step performs heating in such a manner that gold is diffused in said molten solder from said bonding pads.

13. The soldering method according to claim 1, wherein irradiation of said heating beams at least in said pad heating step is performed through an irradiation mask that restricts irradiation areas of said heating beams.

14. The soldering method according to claim 13, wherein irradiation of said heating beams in said molten solder heating step is performed through said irradiation mask.

15. The soldering method according to claim 1, wherein said heating beams are irradiated, respectively, to said each bonding pad as irradiation targets.

16. The soldering method according to claim 15, wherein said heating beams are irradiated simultaneously to said bonding pads which are positioned at a plurality of junction areas, respectively.

17. The soldering method according to claim 15, wherein said heating beams are irradiated, respectively, with intensities set in advance in accordance with positions of said bonding pads.

18. The soldering method according to claim 15, wherein said heating beams are irradiated, respectively, with intensities set in advance in accordance with each of said bonding pads.

19. A head gimbal assembly, wherein a magnetic head slider is bonded to a suspension by said soldering method according to claim 1.

20. A magnetic disk device, comprising said head gimbal assembly according to claim 19 loaded thereon.

21. A soldering apparatus used for bonding, by solder, each bonding pad formed on respective bonding targets to be bonded to each other, said apparatus comprising
an irradiation device having a nozzle for irradiating heating beams to a junction area, and a control device for controlling irradiation state of said heating beams through controlling action of said irradiation device, wherein:
at a tip of said nozzle, there are formed a solder irradiation hole for irradiating said heating beams to solder placed on irradiation paths of said heating beams and bonding-pad irradiation holes for irradiating said heating beams to said bonding pads; and
said control device controls action of said irradiation device to irradiate said heating beams, respectively, to said junction area, before and after said solder is melted.

22. The soldering apparatus according to claim 21, wherein, before melting said solder, said control device controls action of said irradiation device to irradiate said heating beams in an amount of heat with which said solder is not melted within a prescribed time.

23. The soldering apparatus according to claim 21, wherein, before melting said solder, said control device controls action of said irradiation device to irradiate said heating beams with an intensity weaker than that of irradiation for melting said solder.

24. The soldering apparatus according to claim 21, wherein, after said solder is melted, said control device controls action of said irradiation device to irradiate said heating beams with an intensity weaker than that of irradiation for melting said solder.

25. The soldering apparatus according to claim 21, wherein said control device controls action of said irradiation device to irradiate said heating beans continuously.

26. The soldering apparatus according to claim 21, wherein said irradiation device irradiates said heating beams to solder placed in advance on said bonding pads.

27. The soldering apparatus according to claim 21, wherein said irradiation device performs soldering under a state where said solder is held at said tip of said nozzle.

28. The soldering apparatus according to claim 21, wherein said irradiation device performs soldering by supplying solder to said tip of said nozzle after starting irradiation of said heating beams to said each bonding pad.

29. The soldering apparatus according to claim 27, wherein said irradiation device performs soldering by discharging said solder placed at said tip of said nozzle onto said bonding pads to attach said solder thereon.

30. The soldering apparatus according to claim 21, wherein said bonding-pad irradiation holes are formed in a shape, size, or at positions with which said heating beams can be irradiated to said bonding pads through a periphery of said solder.

31. The soldering apparatus according to claim 30, wherein said bonding-pad irradiation holes are formed in a size so that, when said heating beams passed through said bonding-pad irradiation holes are irradiated to said bonding pads, irradiation areas thereof do not exceed areas of said bonding pads.

32. A soldering apparatus used for bonding, by solder, each bonding pad formed on respective bonding targets to be bonded to each other, said apparatus comprising
an irradiation device having a nozzle for irradiating heating beams to a junction area, and a control device for controlling irradiation state of said heating beams through controlling action of said irradiation device, wherein:
said nozzle of said irradiation device is formed to be capable of irradiating said heating beams, respectively, to said each bonding pad as irradiation targets; and
said control device controls action of said irradiation device to irradiate said heating beams, respectively, before and after melting said solder.

33. The soldering apparatus according to claim 32, wherein said irradiation device irradiates said heating beams simultaneously to a plurality of said bonding pads which are positioned at a plurality of junction areas, respectively.

34. The soldering apparatus according to claim 32, wherein said control device performs irradiations, respectively, with Intensities set in advance in accordance with positions of said bonding pads.

35. The soldering apparatus according to claim 32, wherein said control device performs irradiations, respectively, with intensities set in advance in accordance with each of said bonding pads.
